(19) United States
(12) Patent Application Publication
(10) Pub. No.: US 2004/0174838 A1
(43) Pub. Date: Sep. 9, 2004

(54) Method and arrangement for controlling network resources in mobile communication network

(76) Inventor: Eero Sillasto, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/462,819

(22) Filed: Jun. 17, 2003

Related U.S. Application Data
(60) Provisional application No. 60/451,252, filed on Mar. 4, 2003.

(51) Int. Cl. H04Q 7/00

(52) U.S. Cl. 370/328

(57) ABSTRACT

An arrangement in a mobile communication network and a method control network resources for packet data connections in a mobile communication network. The method comprises monitoring packets transmitted on at least one packet connection using a Wireless Transaction Protocol (WTP) in the network; analyzing WTP header information of the packets and optimizing the usage of radio access resources on the basis of the header information.

### CROSS-REFERENCE TO RELATED APPLICATIONS

This application claims priority of U.S. Provisional Patent Application Serial No. 60/451,252 entitled, “Method and Arrangement for Controlling Network Resources in Mobile Communication Network,” filed Mar. 4, 2003, the entire contents of which are incorporated herein by reference.

### BACKGROUND OF THE INVENTION

1. Field of the Invention

The invention relates to a method and arrangement for controlling network resources for packet data connections in a mobile communication network.

2. Description of the Related Art

In modem communication systems there exist several different services in addition to speech services. New service concepts are actively developed. Different data services are popular among users as they are used to carrying a mobile phone with them all the time and thus these services are readily at hand.

Different services need different resources from the network. Especially in mobile communication systems the allocation of resources is a task of utmost importance, because the capacity of the networks is limited. Resource allocation is a difficult task because the available capacity is changing constantly due to changing traffic load and to different services needing resources. The resource allocation is difficult particularly for packet data traffic, because the traffic load is generally bursty. This means that the traffic is not a continuous flow of data, but the needed capacity may vary considerably as a function of time. Examples of packet data connections are non real-time (NRT) connections, such as web browsing, email and WAP (wireless Application Protocol) traffic.

In packet data connections information is transferred in packets over the network. Several protocols have been developed to efficiently handle packet connections. One such protocol is WTP (Wireless Transaction Protocol), which is used, for example, in UMTS (Universal Mobile Telecommunications System).

In prior art, such as in UTRAN (UMTS Terrestrial Radio Access Network), resource allocation for packet traffic is performed at the beginning of the connection. One particular problem concerns detecting when to release the allocated resources. One solution has been to use an inactivity timer to detect inactivity on the connection. When the timer expires and no activity has been detected the resources reserved for the connection are released. The problem with this solution is to select the correct length for the timer. Also the amount of resources that should be allocated especially for a NRT connection is difficult to determine.

### SUMMARY OF THE INVENTION

An objective of the invention is to provide an improved solution for controlling network resources. According to one embodiment of the invention, there is provided a method for controlling network resources for packet data connections in a mobile communication network. The method comprises the steps of: monitoring packets transmitted on at least one packet connection using a Wireless Transaction Protocol in the network; analyzing WTP header information of the packets; and optimizing the usage of radio access resources on the basis of the header information.

According to another embodiment of the invention, there is provided an arrangement in a mobile communication network for controlling network resources for packet data connections. The arrangement comprises a network element configured to monitor packets transmitted on at least one packet connection using a Wireless Transaction Protocol in the network; to analyze WTP header information of the packets; and to optimize the usage of radio access resources on the basis of the header information.

The method and arrangement of the invention can be applied in mobile communication networks utilizing packet data connections and where the transmitted packets comprise header information. For example, radio access networks UTRAN, IP RAN (Internet Protocol Radio Access Network) and GERAN (GSM EDGE Radio Access Network) are such networks. Those access networks offer WAP (Wireless Application Protocol) transactions as a platform for web browsing, multimedia messages and email. WAP is typically realized using WTP (Wireless Transaction Protocol) as transport/transaction protocol. WTP packets contain a header, which comprises information about the transaction. According to one embodiment of the invention the properties of WTP are utilized in a manner to optimize the resource allocation of access network.

The invention provides several advantages. For example, in one embodiment of the invention the resources can be released as soon as the transaction has ended without the need for long timers. In another embodiment of the invention the resource allocation may be performed taking into account the information in the header of the first packet. Furthermore, in a further embodiment of the invention the headers of the transmitted packets are monitored and the resource allocation of the connection may be changed dynamically during the transaction.

### BRIEF DESCRIPTION OF THE DRAWINGS

In the following, the invention will be described in greater detail with reference to the preferred embodiments and the accompanying drawings, in which

FIG. 1 shows an example of a mobile communication network according to an embodiment of the invention;

FIG. 2 illustrates the use of segmentation in packet transfer according to an embodiment of the invention,

FIG. 3 illustrates the use of extended segmentation in packet transfer according to an embodiment of the invention,

FIGS. 4A and 4B illustrate examples of embodiments of the invention; and

FIGS. 5A and 5B illustrate examples of embodiments of the invention.

### DETAILED DESCRIPTION OF THE PREFERRED EMBODIMENTS

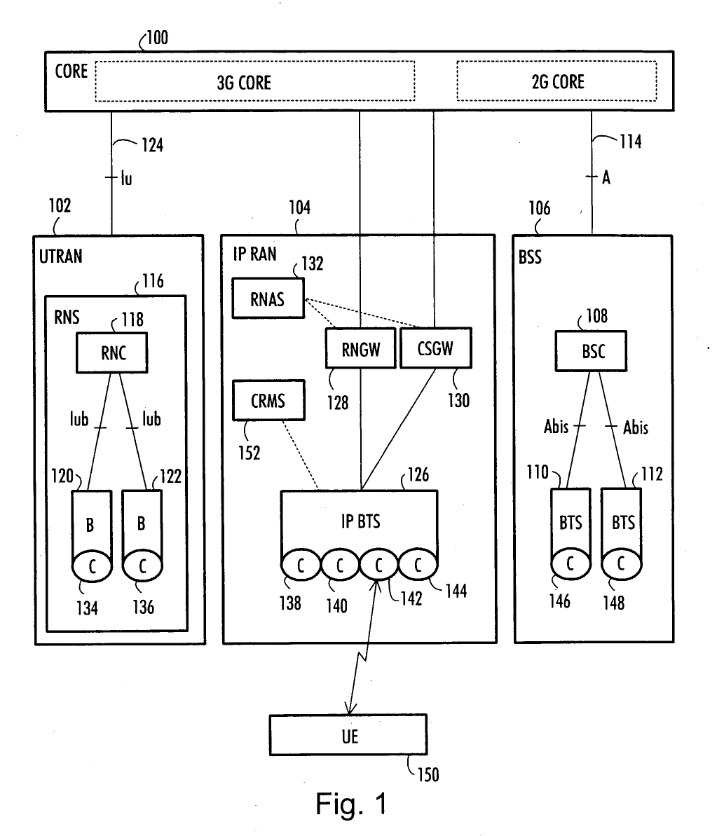

FIG. 1 illustrates an example of a mobile communication network in which embodiments of the invention can be applied. FIG. 1 illustrates a simplified radio system, which comprises the main parts of a radio system: a core network (CN) 100, radio access networks 102, 104, 106 and user equipment (UE) 150.

FIG. 1 shows the general architecture of an evolutionary Third Generation (3G) radio system using different technologies and interoperation of different generations of radio access networks, wherein network elements of different generations coexist. The radio system of the 2.5 generation (2.5G) radio system is represented by a radio system which is based on the GSM (Global System for Mobile Communications), and which uses the EDGE technique (Enhanced Data Rates for Global Evolution) for increasing the data transmission rate, and which can also be used for implementing packet transmission in the GPRS system (General Packet Radio System). The third generation radio system is represented by a radio system which is known at least by the names IMT-2000 (International Mobile Telecommunications 2000) and UMTS (Universal Mobile Telecommunications System).

The Base Station Subsystem (BSS) 106 which is based, for example, on the GSM consists of a base station controller (BSC) 108 and base transceiver stations (BTS) 110, 112. The base station controller 108 controls the base transceiver stations 110, 112. The interface 114 between the core network 100 and the BSS 106 is called A. The interface between the BSC 108 and BTS 110, 112 is called A-bis. Generally the devices implementing the radio path and their functions may be located in the base transceiver station 110, 112 and the management devices in the base station controller 108. Different implementations may, however, naturally exist.

The UMTS Radio Access Network (UTRAN) 102 consists of radio network subsystems 116. Each Radio Network Subsystem (RNS) 116 consists of radio network controllers (RNC) 118 and one or more nodes B 120, 122. Node B is a term that may represent a ‘base station’. The interface between the different radio network subsystems RNS 116 is called Iur. The interface 124 between the core network 100 and the UTRAN 102 is called Iu. The interface between the RNC 118 and node B 120, 122 is called Iub. In respect to its functionality, the radio network controller 118 approximately corresponds to the base station controller 108 of the GSM system and the node B 120, 122 to the base station 110, 112 of the GSM system. In other embodiments, the invention may be configured where the same device functions both as the base station and as the node B, i.e. the device can simultaneously implement a TDMA (Time Division Multiple Access) and a Wideband Code Division Multiple Access (WCDMA) radio interface.

The radio system may use an IP technology based radio access network, i.e. an IP RAN (Internet Protocol Radio Access Network) 104. FIG. 1 shows, according to one embodiment, the role of the IP RAN 104 in the radio system, using the IP RAN 104 as an example of a radio access network (RAN) to which the embodiments can be applied. The IP RAN 104 is a radio access network platform based on IP-technology. The IP RAN 104 also enables interoperation with other, more conventional radio network access technologies and networks, such as the UTRAN (UMTS Radio Access Network) and GERAN (GSM EDGE Radio Access Network).

The IP RAN 104 includes the IP base stations (IP BTS) 126 which are connected to radio access network gateways that are the access points between the IP RAN and the core network and other radio access networks. Radio Access Network Gateway (RNGW) 128 provides a gateway for packet switched connections and Circuit Switched Gateway (CSGW) 130 provides a gateway for circuit switched connections. Both gateways are controlled by a Radio Access Network Server (RNAS) 132. The IP RAN typically further comprises a common resource management server (CRMS) 152, which is responsible for managing the radio resources between the base stations and the user equipment in the radio network. The IP RAN may also comprise other common servers and routers not illustrated in FIG. 1 for the sake of clarity. All possible connections between different entities in FIG. 1 are not shown for the sake of clarity.

In IP RAN 104, most of the functions of the centralized controller (RNC 118 and BSC 108) may be moved to the IP base station 126. In particular, all the radio interface protocols are terminated at the IP base station 126. Entities outside the IP base station 126 may be used for example to perform common configuration and radio resource (RR) functions, or to interwork with conventional radio access networks or base station subsystems or gateways to the core network 100.

FIG. 1 also illustrates the coverage areas, i.e. cells, of the base stations of the different radio access networks. Cells 134 and 136 thus represent the coverage areas of nodes B 120 and 122, and cells 146 and 148 represent the coverage areas of the base stations 110 and 112. One node B 120, 122, or base station 110, 112 may either serve one cell, as illustrated in FIG. 1, or several cells which in the case of base stations, can be sectored cells. The coverage area of the IP base station (IP BTS) 126, is represented by multiple cells 138 to 144 in the figure, but an IP BTS may also serve just one cell.

User equipment 150 illustrated in FIG. 1 is in this example applicable to both 2G and 3G systems, comprising at least one transceiver for establishing a radio connection to the radio access network 104. Typically, user equipment 150 is a mobile station, further comprising an antenna, a user interface and a battery. Various kinds of user equipment 150 are available, e.g. equipment installed in a car and portable equipment, and user equipment 150 can also have properties similar to those of a personal computer or a portable computer. User equipment 150 is connected to the radio system via the base stations of a radio access network, such as the IP RAN 104, for providing the user with access to the core network of the telecommunications system.

In an embodiment of the invention where a packet data transaction protocol is applied, in general, a transaction requires two participants, namely an initiator initiating a transaction and a responder providing a response to a transaction. A transaction may be defined as a unit of interactions between two participants. The initiator sends an invoke message to the responder. The responder receives the message and may provide a response to the initiator if required. The type of transaction is typically defined in the invoke message. A session between the participants may comprise several consecutive messages. In a transaction a mobile may, for example, request a response from a WAP server.

Messages may be sent using one or more packets depending on the size of the messages. For example, in WTP, if the length of a message to be transmitted exceeds the length defined as the maximum transmission unit (MTU) for the bearer of a connection, the message may be divided or segmented and sent using several packets. Furthermore, if the number of the packets is large, the packets may be divided into groups. This may be called segmentation. The responder may then acknowledge the packets in groups or acknowledge each packet separately. The transmission of groups may wait for acknowledgements before continuing or the transmission may continue and the acknowledgement of a group may be sent during the transmission of the following group or groups. This latter case may be called extended segmentation. Selective retransmission may be used to resend erroneously received packets, but these features are not described here, as they are known to one skilled in the art.

Each packet comprises a header comprising a fixed part and optionally a variable part. The fixed part contains most common parameters and information on packet type. Variable part may contain optional parameters. The existence of the variable part is indicated in the fixed part of the header. Each packet may in addition comprise a section for user data.

The fixed part of the header comprises information concerning the segmentation of messages. The header comprises Group Trailer Flag (GTR) and Transmission Trailer Flag (TTR). These flags are used to indicate the usage of the segmentation and the last packets of groups and messages according to the following table:

TABLE 1
GTR and TTR Flag values

| GTR | TTR | Packet |
|---|---|---|
| 0 | 0 | Not last packet of a group or message |
| 0 | 1 | Last packet of a message |
| 1 | 0 | Last packet of a group |
| 1 | 1 | Segmentation not supported |

Thus, by analyzing the values of these flags, the responder may determine which packet is the last packet of a group or a message.

The existence of the variable part in the header of a packet is indicated in the fixed part. The variable part may contain optional fields, which can be used for transferring parameters between the participants of the transaction. These parameters may be valid for the duration of the whole transaction.

The variable part may contain a parameter indicating a NumGroups-parameter, which indicates whether the transmitter of the packet supports extended segmentation of messages and what the maximum number of outstanding (not acknowledged groups) is. The variable part may contain a Maximum Group-parameter, which indicates the maximum supported group size in bytes. The variable part may also contain a parameter indicating the maximum unit of data in bytes that can be received.

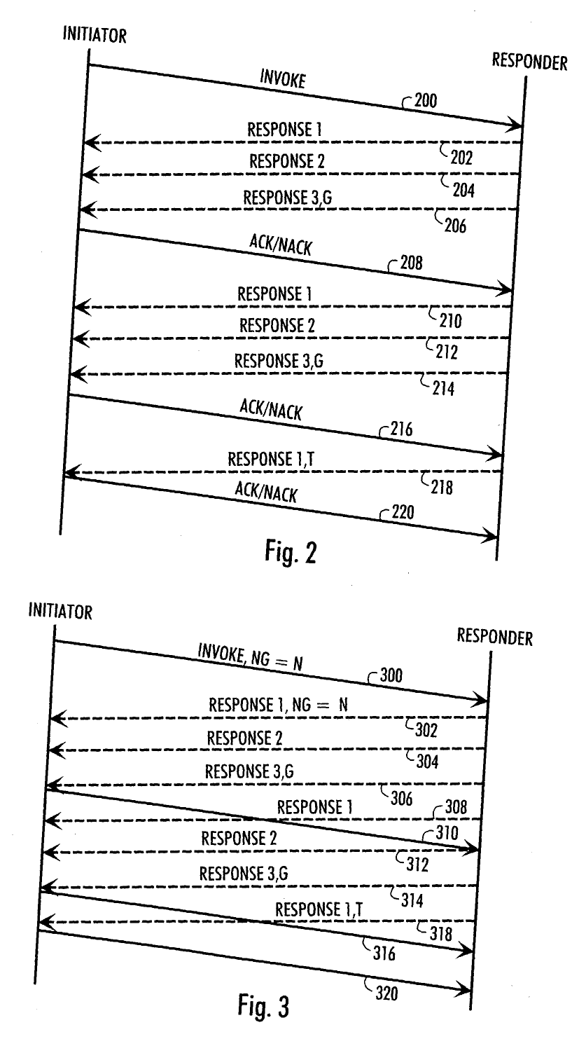

FIG. 2 illustrates the use of segmentation. First, the initiator sends an invoke message 200 to the responder. The message may contain a service request, but in this example it is not relevant. The responder responds to the invoke message with a response that does not fit into one message typically because the maximum Transaction Unit (MTU) of the bearer of the connection does not allow the response to be transmitted in one message. The message will thus be sent in several packets, in this example seven packets. The initiator may in the invoke message inform the responder about the maximum amount of data per group the initiator supports. On the basis of this information the responder divides the messages into groups. In this example, the number of packets in a group is at most three.

First, the responder sends one response packet 202, then followed by another 204. In both of these packets the GTR and TTR flags are not set. In the next packet 206, which is the last packet, the GTR flag is set. This triggers an acknowledgement message 208 from the initiator. In this example, it is assumed, for simplicity, that all packets are received correctly. If the flags are not set, retransmissions will occur.

After receiving the acknowledgement message from the initiator the responder sends the next group of packets 210 to 214, and in the last packet 214 of the group the GTR flag is set. The initiator sends an acknowledgement message 216. Last, the responder sends the last remaining message 218. In this packet TTR flag is set. Thus the initiator detects that this packet is the last packet of the last group of message, and sends the final acknowledgement message 220.

FIG. 3 illustrates another example of segmentation. In this example extended segmentation is used. The sending party does not wait for acknowledgements at the end of each group. Instead, a sliding window technique is used. At the beginning of each transaction the participants negotiate the number of groups in a sliding window. The number of groups may also be selected as in the previous example. If a message is divided into several groups, the sender may send packets continuously and the receiving end may send acknowledgements in a more flexible manner. The size of the sliding window means the maximum number of groups outstanding (i.e. not acknowledged). For example, if the size of the window is three, the receiver may have three groups outstanding before the transmitting party stops sending and waits for acknowledgements. In an optimal situation, the transmission is continuous as the receiving party may send acknowledgment for a previous group while receiving the packets of the next group. If the size of the sliding window is one, the procedure is similar to the example of FIG. 2.

First, the initiator sends an invoke message 300 to the responder. The message comprises a field containing a value N for the size of the sliding window supported by the initiator. In this example the value N has been set to be greater than one. The responder receives the invoke message and agrees with the value N. In the first response packet 302 the responder confirms the value to the initiator. The first group of the packets that the responder transmits contains three packets 302 to 306 and in the last packet 306, the GTR flag is set. However, in contrast to the solution described in FIG. 2, the responder does not wait for an acknowledgement from the initiator as N is greater than 1 and the number of non-acknowledged groups is smaller than N. The responder thus transmits the first packet 308 of the next group. Meanwhile, the initiator has detected the last packet of the first group and sends an acknowledgement packet 310. The responder sends the rest of the packets 312, 314 of the second group, the last packet 314 having the GTR flag on. The initiator acknowledges 316 the second group. The responder does not wait for the acknowledgement but sends the last packet 318 with the TTR flag on. The initiator acknowledges 320 the packet.

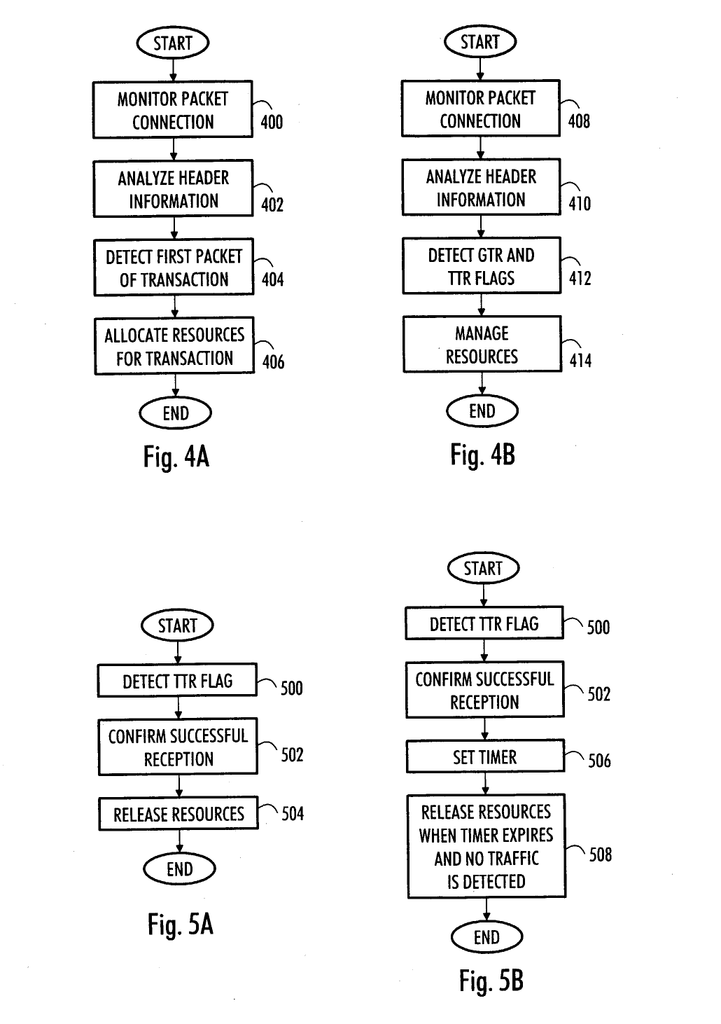

An embodiment of the invention is illustrated in FIG. 4A. Packets transmitted on a packet connection in the network are monitored 400. Header information of the packets is analyzed 402. The first packet of a transaction is detected 404 by analyzing the header information of the packets. For example, when applying the invention to the Wireless Transaction Protocol, the fixed header of each packet comprises the PDU type (Packet Data Unit type) and the first packet of a transaction may be configured as an Invoke PDU type to be included in the invoke message. In the embodiment, resources for the transmission of the transaction are allocated 406 on the basis of the header information.

The embodiment described above may also be generalized to include not only the invoke messages but all messages. This allows a dynamical change of resource management behavior during transaction. For example, resource allocation may be changed if the sliding window is increased or decreased during transaction.

An embodiment of the invention is illustrated in FIG. 4B. Packets transmitted on a packet connection or transaction in the network are monitored 408. Header information of the packets is analyzed 410. Values of the GTR and TTR flags of response messages are read 412. The resources of the transaction are controlled 414 on the basis of the header information. As described above the flags indicate for example the last packet of a response message. If such a packet has been detected, the resources reserved for the transaction can be released after the packet has been successfully received at the receiver end. This can be checked using known methods, such as for example from PDCP layer (Packet Data Convergence Protocol layer). The protocol is known to one skilled in the art and not described further here. Resource allocation may also be updated on the basis of the header information.

The parameters of the variable part of the header of the packet may be utilized in optimizing the usage of network resources. For example, when extended segmentation is used, the maximum amount of unacknowledged data can be calculated by multiplying NumGroup and MaximumGroup parameters. This calculation gives an indication (in bytes) of the allocated bit rate. The round trip time of messages is not known, but an estimation of the minimum value (RTTmin in milliseconds) can be made, and allocated bit rate can be, for example in the order of: (NumGroup*MaximumGroup)*8/RTTmin [in kbps]. The participants of the transaction can change NumGroup and MaximumGroup parameters during the transaction for performing flow control. Based upon these changes, the allocations can be reconsidered.

In case of segmentation, the allocated bit rate can be calculated in the same manner (NumGroups parameter has in this case the value of one), but it should be also taken into account that the traffic is always bursty as segmentation uses a stop-and-wait protocol. A group is not sent until acknowledgement of the previous group has arrived. The participants of the transaction can change MaximumGroup parameter during the transaction for performing flow control. Then, based upon this change, the allocations can be reconsidered.

An alternative embodiment of FIG. 4B is described in FIG. 5A. When a TTR flag has been detected 500, it is known that the last packet of a response message has been detected, after which the resources of the transaction are released 504.

In another embodiment of FIG. 5B, when a TTR flag has been detected 500, it is known that the last packet of a response message has been detected. Respectively, the successful reception of that packet is confirmed 502 using known methods. Now an inactivity timer is set 506 for the resources reserved for the transmission of the message on the basis of the detection. When the timer has expired and no traffic has been detected, the resources are released 508.

In a further embodiment of the invention, if the header of a packet indicates that the invoke message transmitted in the packet needs no response from the recipient, the resources can be released after the packet has been delivered successfully.

In another embodiment of the invention, if the header of a packet indicates that segmentation is not used (both TTR and GTR flags having a value 1), it can be assumed that the response will be short, and the required resources are small.

Typically the resources that can be controlled in the described ways are non real-time connections, but the invention is not however limited to this description. The resources can be controlled separately in uplink and downlink directions.

The embodiments of the invention may be advantageously implemented in a network element responsible for resource management of a mobile communication network. Referring to FIG. 1, the network element may be a radio network controller (RNC) 118, an IP base station (IP BTS) 126, or a base station controller 108. The implementation can typically be realized with suitable software.

Even though the invention is described above with reference to an example according to the accompanying drawings, it is clear that the invention is not restricted thereto but it can be modified in several ways within the scope of the appended claims.

1. A method for controlling network resources for packet data connections in a mobile communication network, the method comprising:
monitoring packets transmitted on at least one packet connection using a Wireless Transaction Protocol in a network;
analyzing header information of at least one packet; and optimizing a usage of radio access resources based on the header information.

2. The method of claim 1, further comprising:
monitoring transmissions of messages comprising at least one group of packets.

3. The method of claim 1, further comprising:
detecting a last packet of a message based on the header information of the at least one packet; and
releasing resources reserved for transmitting the message.

4. The method of claim 1, further comprising:
detecting a last packet of a message based on the header information of the at least one packet; and
activating an inactivity timer for a predetermined time for resources reserved for transmitting the message based on detecting the last package; and
releasing the resources reserved for transmitting when the predetermined time expires.

5. The method of claim 1, further comprising:
detecting information relating to at least one of a size of a message and a bit rate needed in transmitting a message.

6. The method of claim 2, comprising:
detecting information relating to a maximum number of groups used in transmitting a message or a bit rate needed in transmitting a message.

7. The method of claim 2, further comprising:
detecting information relating to a maximum size of a group used in transmitting a message.

8. The method of claim 1, wherein the at least one packet connection comprises a non real-time data connection.

9. The method of claim 1, further comprising:
detecting a first packet of a transaction by analyzing the header information of the at least one packet to be transmitted; and
allocating resources for transmitting a message based on the header information.

10. The method of claim 1, further comprising:
analyzing header information of packets of a message being transmitted; and
reallocating resources for the message based on the header information.

11. The method of claim 1, wherein the step of optimizing further comprises optimizing the radio access resources separately for uplink and downlink directions.

12. An arrangement in mobile communication network for controlling network resources for packet data connections, the arrangement comprising a network element configured:
to monitor packets transmitted on at least one packet connection using a Wireless Transaction Protocol in a network;
to analyze header information of at least one packet; and
to optimize a usage of radio access resources, based on the header information.

13. The arrangement of claim 12, further comprising a network element configured to monitor transmissions of messages comprising at least one group of packets.

14. The arrangement of claim 12, further comprising a network element to detect a last packet of a message based on the header information of the at least one packet; and
to release resources reserved for transmitting a message.

15. The arrangement of claim 12, further comprising a network element configured to detect a last packet of a message based on the header information of the at least one packet;
to activate an inactivity timer for a predetermined time for resource reserved for transmitting a message based on detecting the last package; and
to release the resources reserved for transmitting when the predetermined time expires.

16. The arrangement of claim 12, further comprising a network element configured to detect information relating to at least one of a size of a message and a bit rate needed in transmitting a message.

17. The arrangement of claim 12, further comprising a network element configured to detect a first packet of a message by analyzing the header information of the at least one packet to be transmitted; and
to allocate resources for transmitting the message based on the header information.

18. The arrangement of claim 13, further comprising a network element configured to detect information relating to a maximum size of a group.

19. The arrangement of claim 12, further comprising a network element configured to analyze header information of packets of a message being transmitted; and
to reallocate resources for transmitting the message based on the header information.

20. The arrangement of claim 12, further comprising a network element configured to monitor non real-time data connections.

21. A network element included within a mobile communication network, the network element comprising:
first monitoring means for monitoring packets transmitted on at least one packet connection using a Wireless Transaction Protocol in a network;
analyzing means for analyzing header information of the at least one packet; and
optimizing means for optimizing a usage of radio access resources based on the header information.

22. The network element of claim 21, further comprising:
second monitoring means for monitoring transmissions of messages comprising at least one group of packets.

23. The network element of claim 21, further comprising:
detecting means for detecting a last packet of a message based on the header information of the at least one packet; and
releasing means for releasing resources reserved for transmitting the message.

24. The network element of claim 21, further comprising:
detecting means for detecting a last packet of a message based on the header information of the at least one packet; and
activating means for activating an inactivity timer for a predetermined time for resources reserved for transmitting a message based on detecting the last package; and
releasing means for releasing the resources reserved for transmitting when the predetermined time expires.
